(19) United States
(12) Patent Application Publication
(10) Pub. No.: US 2011/0041063 A1
(43) Pub. Date: Feb. 17, 2011

(54) METHOD AND APPARATUS FOR PROVIDING SOCIAL NETWORK SERVICE

(76) Inventors: Byoung Wook LEE, Seoul (KR); Min Kyoung Jang, Seoul (KR)

Correspondence Address: BIRCH STEWART KOLASCH & BIRCH, PO BOX 747, FALLS CHURCH, VA, 22040-0747, US

(21) Appl. No.: 12/629,760

(22) Filed: Dec. 2, 2009

(30) Foreign Application Priority Data
Aug. 11, 2009 (KR) 10-2009-74014

(51) Int. Cl. G06F 15/16; H04W 4/12; G06F 3/01

(52) U.S. Cl. 715/733; 455/466; 709/206

(57) ABSTRACT

A method for controlling a mobile terminal including receiving, via a wireless communication unit and using a messaging service on the mobile terminal, a bulletin board invitation message from a host terminal and including an invitation to join a bulletin board created by the host terminal; transmitting, via the wireless communication unit using the messaging service, an acceptance message to the host terminal indicating the mobile terminal accepts the invitation for joining the bulletin board created by the host terminal; displaying, on a display of the mobile terminal, the bulletin board created by the host terminal; and transmitting, via the wireless communication unit using the messaging service, contents to be displayed on the bulletin board to the host terminal.

### CROSS-REFERENCE TO A RELATED APPLICATION

The present application claims priority under 35 U.S.C. 119 and 35 U.S.C. 365 to Korean Patent Application No. 10-2009-0074014 filed on Aug. 11, 2009, which is hereby incorporated by reference in its entirety.

### BACKGROUND OF THE INVENTION

1. Field of the Invention

The present disclosure relates to a mobile terminal and corresponding method for providing a social network service (SNS).

2. Discussion of the Background

A short message service (SMS) enables exchange of short text messages between mobile phone users. The SMS is a simple text message having a limited length. However, inputting text messages to chat with a plurality of users is often cumbersome and time consuming.

### SUMMARY OF THE INVENTION

Accordingly, one aspect of the present invention is to address the above-noted and other problems.

To achieve these and other advantages and in accordance with the purpose of the present invention, as embodied and broadly described herein, the present invention provides in one aspect a method for controlling a mobile terminal including receiving, via a wireless communication unit using a messaging service on the mobile terminal, a bulletin board invitation message from a host terminal and including an invitation to join a bulletin board created by the host terminal; transmitting, via the wireless communication unit using the messaging service, an acceptance message to the host terminal indicating the mobile terminal accepts the invitation for joining the bulletin board created by the host terminal; displaying, on a display of the mobile terminal, the bulletin board created by the host terminal; and transmitting, via the wireless communication unit using the messaging service, contents to be displayed on the bulletin board to the host terminal.

In another aspect, the present invention provides a mobile terminal including a wireless communication unit configured to use a messaging service to receive a bulletin board invitation message from a host terminal and including an invitation to join a bulletin board created by the host terminal, and to transmit using the messaging service an acceptance message to the host terminal indicating the mobile terminal accepts the invitation for joining the bulletin board created by the host terminal; and a display configured to display the bulletin board created by the host terminal. Further, the wireless communication unit is further configured to transmit contents to be displayed on the bulletin board to the host terminal using the messaging service.

Further scope of applicability of the present invention will become apparent from the detailed description given hereinafter. However, the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a block diagram of a mobile terminal according to an embodiment of the present invention;

FIG. 2 is a configuration diagram of a communication system operable with the mobile terminal according to an embodiment to an embodiment of the present invention;

FIG. 3 is a network diagram of a wireless social networking service (SNS) according to an embodiment of the present invention;

FIG. 4 is an overview of a display screen illustrating a virtual bulletin board invitation message according to an embodiment of the present invention;

FIGS. 5A and 5B are overviews of display screens illustrating a virtual bulletin board according to an embodiment of the present invention;

FIG. 6A is an overview of a display screen illustrating a virtual bulletin board new message notification screen according to an embodiment of the present invention;

FIG. 6B is an overview of a display screen illustrating a virtual bulletin board according to an embodiment of the present invention;

FIG. 7 is a flow chart illustrating a virtual bulletin board generation method according to an embodiment of the present invention;

FIG. 8A is a flow chart illustrating a method for one of virtual bulletin board members to receive contents uploaded to a virtual bulletin board according to an embodiment of the present invention;

FIG. 8B is a flow chart illustrating a method for uploading contents to a virtual bulletin board according to an embodiment of the present invention;

FIG. 9 is a diagram illustrating a network configuration including a dedicated server for operation of a virtual bulletin board according to an embodiment of the present invention;

FIGS. 10A to 10C are flow charts illustrating a virtual bulletin board generation method implementable in a network system of FIG. 9 according to embodiments of the present invention;

FIGS. 11A and 11B are flow charts illustrating a virtual bulletin board contents transmission method implementable in the network system of FIG. 9 according to an embodiment of the present invention;

FIG. 12 is a diagram illustrating a social network designating a receiver whenever uploading texts or contents according to an embodiment of the present invention;

FIG. 13 is an overview of a display screen illustrating a homepage invitation message according to an embodiment of the present invention;

FIG. 14 is an overview of a display screen illustrating a notification message notifying the presence of new contents in a homepage according to an embodiment of the present invention;

FIGS. 15A to 15C are overviews of display screens illustrating a method for transmitting contents by designating a receiver of homepage contents differently depending on the contents according to an embodiment of the present invention;

FIGS. 16A to 16C are overviews of display screens illustrating a homepage displayed on a terminal on a guest-by-guest basis according to an embodiment of the present invention;

FIG. 17 is a flow chart illustrating a mobile homepage generation method implemented in a terminal of a guest of a homepage according to an embodiment of the present invention;

FIG. 18 is a flow chart illustrating a homepage contents reception method according to an embodiment of the present invention;

FIG. 19 is an overview of a display screen illustrating a method for a guest to upload contents to a homepage of a host according to an embodiment of the present invention;

### DETAILED DESCRIPTION OF THE EMBODIMENTS

Reference will now be made in detail to the embodiments of the present disclosure, examples of which are illustrated in the accompanying drawings.

A mobile terminal may be implemented using a variety of different types of terminals. Examples of such terminals include mobile phones, smart phones, notebook computers, digital broadcast terminals, Personal Digital Assistants (PDA), Portable Multimedia Players (PMP), navigators and the like.

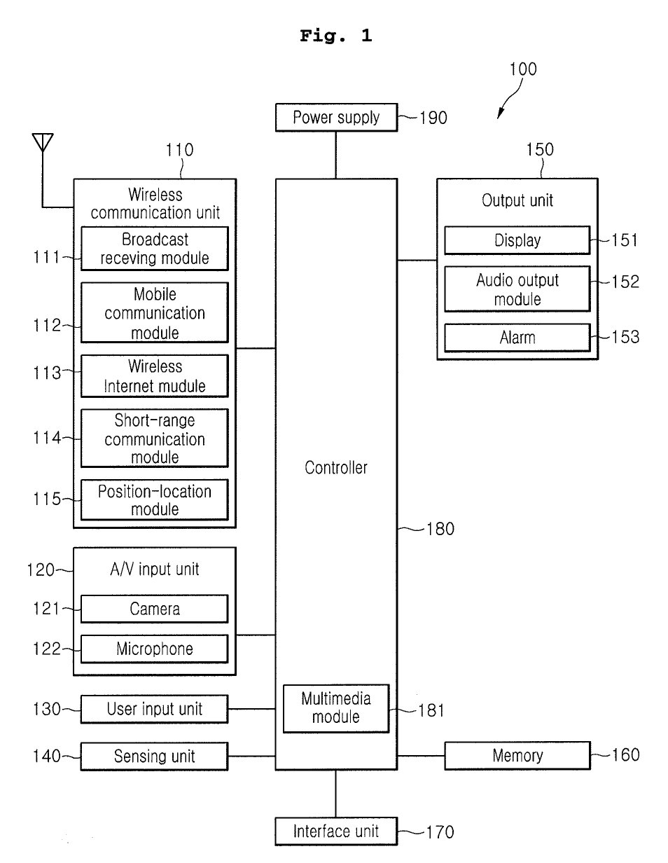

FIG. 1 is a block diagram illustrating a mobile terminal according to one embodiment of the present invention. As shown, the mobile terminal 100 may include components such as a wireless communication unit 110, an Audio/Video (A/V) input unit 120, a user input unit 130, a sensing unit 140, an output unit 150, a memory 160, an interface unit 170, a controller 180, a power supply 190 and the like. Further, FIG. 1 shows the mobile terminal 100 having various components, but it is understood that implementing all of the illustrated components is not a requirement. Greater or fewer components may alternatively be implemented.

In addition, the wireless communication unit 110 may include one or more components which permit wireless communications between the mobile terminal 100 and a wireless communication system or between the mobile terminal 100 and a network within which the mobile terminal 100 is located. For example, in FIG. a, the wireless communication unit 110 includes at least one of a broadcast receiving module 111, a mobile communication module 112, a wireless Internet module 113, a short-range communication module 114 and a position location module 115.

The broadcast receiving module 111 receives a broadcast signal and/or broadcast associated information from an external broadcast managing entity via a broadcast channel. The broadcast channel may include a satellite channel and a terrestrial channel. Further, the broadcast managing entity may indicate a server which generates and transmits a broadcast signal and/or broadcast associated information or a server which receives a pre-generated broadcast signal and/or broadcast associated information and sends them to the mobile terminal. Examples of broadcast associated information may include information associated with a broadcast channel, a broadcast program, a broadcast service provider and the like.

The broadcast signal may be implemented as a TV broadcast signal, a radio broadcast signal and a data broadcast signal, among others. The broadcast signal may further include a data broadcast signal combined with a TV or radio broadcast signal. Also, the broadcast associated information may be provided via a mobile communication network, and received by the mobile communication module 112. In addition, the broadcast associated information may be implemented in various formats. For instance, broadcast associated information may include the Electronic Program Guide (EPG) of the Digital Multimedia Broadcasting (DMB) system, the Electronic Service Guide (ESG) of the Digital Video Broadcast-Handheld (DVB-H) system, and the like.

The broadcast receiving module 111 may be configured to receive digital broadcast signals transmitted from various types of broadcast systems. Such broadcast systems may include the Digital Multimedia Broadcasting-Terrestrial (DMB-T) system, the Digital Multimedia Broadcasting-Satellite (DMB-S) system, the Media Forward Link Only (MediaFLO) system, the Digital Video Broadcast-Handheld (DVB-H) system, the Integrated Services Digital Broadcast-Terrestrial (ISDB-T) system, and the like. The broadcast receiving module 111 may be configured to be suitable for all broadcast system transmitting broadcast signals as well as the digital broadcasting systems. Broadcast signals and/or broadcast associated information received via the broadcast receiving module 111 may also be stored in a suitable device, such as a memory 160.

Further, the mobile communication module 112 transmits/receives wireless signals to/from at least one of network entities (e.g., base station, an external mobile terminal, a server, etc.) on a mobile communication network. In addition, the wireless signals may include an audio call signal, video call signal, or various formats of data according to transmission/reception of text/multimedia messages. Also, the wireless Internet module 113 supports wireless Internet access for the mobile terminal, and may be internally or externally coupled to the mobile terminal. Examples of such wireless Internet access include Wireless LAN (WLAN) (Wi-Fi), Wireless Broadband (Wibro), World Interoperability for Microwave Access (Wimax), High Speed Downlink Packet Access (HSDPA), and the like.

Further, the short-range communication module 114 denotes a module for short-range communications. Suitable technologies for implementing this module include BLUETOOTH, Radio Frequency IDentification (RFID), Infrared Data Association (IrDA), Ultra-WideBand (UWB), ZigBee, and the like. The position location module 115 denotes a module for detecting or calculating a position of a mobile terminal. An example of the position location module 115 includes a Global Position System (GPS) module.

In addition, the GPS module may receive position information in cooperation with associated multiple satellites. Further, the position information may include coordinates information represented by latitude and longitude. For example, the GPS module can measure accurate time and distance respectively from more than three satellites so as to accurately calculate a current position of the mobile terminal based on such three different distances according to a triangulation scheme. A scheme may be used to obtain time information and distance information from three satellites and correct error by one satellite. Specifically, the GPS module can further obtain three-dimensional speed information and an accurate time, as well as position on latitude, longitude and altitude, from the position information received from the satellites.

In addition, the A/V input unit 120 is configured to provide audio or video signal input to the mobile terminal. In FIG. 1, the A/V input unit 120 includes a camera 121 and a microphone 122. Further, the camera 121 receives and processes image frames of still pictures or video obtained by image sensors in a video call mode or a capturing mode. The processed image frames may then be displayed on a display 151.

Also, the image frames processed by the camera 121 may be stored in the memory 160 or transmitted to the exterior via the wireless communication unit 110. Two or more cameras 121 may be provided according to the configuration of the mobile terminal. The microphone 122 may receive an external audio signal via a microphone while the mobile terminal is in a particular mode, such as a phone call mode, a recording mode, a voice recognition mode, or the like. This audio signal is processed into digital data, and the processed digital data is converted for output into a format transmittable to a mobile communication base station via the mobile communication module 112 for the phone call mode. The microphone 122 may also include assorted noise removing algorithms to remove noise generated in the course of receiving the external audio signal.

In addition, the user input unit 130 generates input data input by a user to control the operation of the mobile terminal. The user input unit 130 may include a keypad, a dome switch, a touchpad (e.g., static pressure/capacitance), a jog wheel, a jog switch and the like. A specific example can be one in which the touchpad is layered with the display 151 to be explained later so as to be in cooperation with the display 151, which is referred to as a touch screen. Further, the sensing unit 140 provides status measurements of various aspects of the mobile terminal. For instance, the sensing unit 140 can detect an open/close status of the mobile terminal, a change in a location of the mobile terminal 100, a presence or absence of user contact with the mobile terminal 100, the location of the mobile terminal 100, acceleration/deceleration of the mobile terminal 100 and the like, so as to generate a sensing signal for controlling the operation of the mobile terminal 100.

For example, regarding a slide-type mobile terminal, the sensing unit 140 may sense whether a sliding portion of the mobile terminal is opened or closed. Other examples include sensing functions such as the sensing unit 140 sensing the presence or absence of power provided by the power supply 190, the presence or absence of a coupling or other connection between the interface unit 170 and an external device. The sensing unit 140 may also include a proximity sensor.

In particular, the proximity sensor may be arranged at an inner region of the mobile terminal covered by the touch screen, or near the touch screen. The proximity sensor 141 indicates a sensor to sense presence or absence of an object approaching to a surface to be sensed, or an object disposed near a surface to be sensed, by using an electric field or infrared rays without a mechanical contact. The proximity sensor has a longer lifespan and a more enhanced utilization degree than a contact sensor.

The proximity sensor may include a transmissive type photoelectric sensor, a direct reflective type photoelectric sensor, a mirror reflective type photoelectric sensor, a high-frequency oscillation type proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electric field. In this case, the touch screen (touch sensor) may be categorized into a proximity sensor.

Also, a status that the pointer is positioned to be proximate onto the touch screen without contact is referred to as ‘proximity touch’, whereas a status that the pointer substantially comes in contact with the touch screen is referred to as ‘contact touch’. The pointer in a status of ‘proximity touch’ is positioned so as to be vertical with respect to the touch screen. The proximity sensor also senses proximity touch, and proximity touch patterns (e.g., distance, direction, speed, time, position, moving status, etc.). Information relating to the sensed proximity touch, and the sensed proximity touch patterns may be output onto the touch screen.

In addition, the interface unit 170 is generally implemented to couple the mobile terminal to external devices. The interface unit 170 may include, for example, wired/wireless headset ports, external charger ports, wired/wireless data ports, memory card ports, ports for coupling devices having an identification module, etc., audio Input/Output (I/O) ports, video I/O ports, earphone ports, and the like. The identification module may be configured as a chip for storing various information required to authenticate an authority to use the mobile terminal 100, which may include a User Identity Module (UIM), a Subscriber Identity Module (SIM), a Universal Subscriber Identity Module (USIM), and the like. Also, the device having the identification module (hereinafter, referred to as ‘identification device’) may be implemented in a type of smart card. Hence, the identification device can be coupled to the mobile terminal 100 via a port.

In addition, the interface unit 170 may receive data from an external device, or be provided with power and accordingly transfer the received data or power to each component within the mobile terminal 100 or transfer data of the mobile terminal 100 to an external device. Also, the interface unit 170 may serve as a path for power to be supplied from an external cradle to the mobile terminal 100 when the mobile terminal 100 is connected to the external cradle or as a path for transferring various command signals inputted from the cradle by a user to the mobile terminal 100. Such various command signals and power inputted from the cradle may operate as a signal for recognizing that the mobile terminal 100 has accurately been mounted to the cradle.

The output unit 150 is configured to output an audio signal, a video signal or an alarm signal, and may include the display 151, an audio output module 152, an alarm 153, and the like. Further, the display 151 may output information processed in the mobile terminal 100. For example, when the mobile terminal is operating in a phone call mode, the display 151 provides a User Interface (UI) or a Graphic User Interface (GUI) which includes information associated with the call. As another example, if the mobile terminal is in a video call mode or a capturing mode, the display 151 may additionally or alternatively display images captured and/or received, UI, or GUI.

Meanwhile, as mentioned above, a touch screen can be configured as the display 151 and the touchpad are layered with each other to work in cooperation with each other. This configuration permits the display 151 to function both as an input device and an output device. The display 151 may be implemented using, for example, a Liquid Crystal Display (LCD), a Thin Film Transistor-Liquid Crystal Display (TFT-LCD), an Organic Light-Emitting Diode (OLED), a flexible display, a three-dimensional (3D) display, or the like.

Some of the displays according to embodiments of the present invention can be configured to be transparent such that it is possible to see the exterior therethrough. These displays may be called transparent displays. A representative example of the transparent display includes a Transparent Organic Light Emitting Diode (TOLED), and the like. Further, the mobile terminal 100 may include two or more of such displays 151. For example, the mobile terminal 100 may simultaneously include an external display and an internal display.

Further, the audio output module 152 may output audio data which is received from the wireless communication unit 110 in various modes including a call-receiving mode, call-placing mode, recording mode, voice recognition mode, broadcast reception mode, and the like, or audio data stored in the memory 160. Also, the audio output module 152 may output an audio signal relating to a particular function (e.g., call received, message received, etc.) performed in the mobile terminal 100. The audio output module 152 may be implemented using a speaker, a buzzer, or the like.

In addition, the alarm 153 may output a signal to inform a generation of event associated with the mobile terminal 100. Alarm events may include a call received, message received, user input received and the like. In addition to generating the audio or video signal, the alarm 153 may also inform the event generation in different manners, for example, by providing tactile sensations (e.g., vibration) to a user. The alarm 153 may also be configured to vibrate responsive to the mobile terminal receiving a call or message. As another example, vibration is provided by the alarm 153 responsive to receiving user input at the mobile terminal, thus providing a tactile feedback mechanism. Such vibration can also be provided to make a user recognize the event generation. The signal informing the event generation may be output via the display 151 or the audio output module 152.

Further, the memory 160 may store a program for the processing and control of the controller 180. Alternatively, the memory 160 may temporarily store input/output data (e.g., phonebook data, messages, still images, video and the like). Also, the memory 160 may store data related to various patterns of vibrations and audio output upon the touch input on the touch screen. In addition, the memory 160 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, optical disk, and the like. Also, the mobile terminal 100 may operate a web storage which performs the storage function of the memory 160 on the Internet.

In addition, the controller 180 generally controls the overall operations of the mobile terminal. For example, the controller 180 performs the control and processing associated with voice calls, data communications, video calls, and the like. In FIG. 1, the controller 180 also includes a multimedia module 181 which provides multimedia playback. The multimedia module 181 may be configured as part of the controller 180 or as a separate component. The controller 180 can also perform a pattern recognition processing so as to recognize writing or drawing input on the touch screen as text or image. Further, the power supply 190 provides power required by various components under the control of the controller 180. The provided power may be internal power, external power, or combination thereof.

Various embodiments described herein may be implemented in a computer-readable medium using, for example, software, hardware, or some combination thereof. For a hardware implementation, the embodiments described herein may be implemented within one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller 180.

For software implementation, the embodiments such as procedures and functions may be implemented together with separate software modules each of which performs at least one of functions and operations. The software codes can be implemented with a software application written in any suitable programming language. Also, the software codes may be stored in the memory 160 and executed by the controller 180.

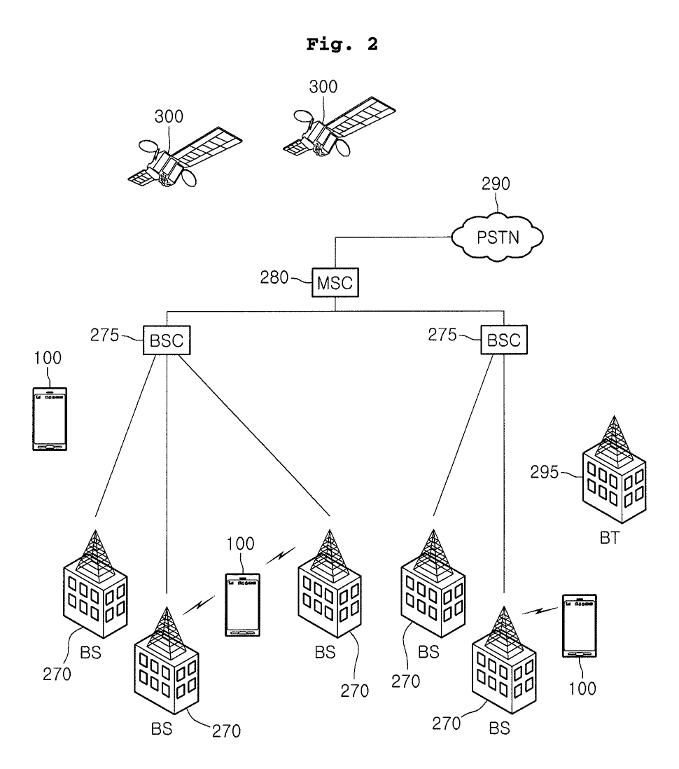

The mobile terminal 100 of FIG. 1 may also be configured to operate within a communication system which transmits data via frames or packets, including both wireless and wireline communication systems, and satellite-based communication systems. Hereinafter, a communication system within which the mobile terminal related to the present invention can operate will be described with reference to FIG. 2. Such communication systems utilize different air interfaces and/or physical layers. Examples of such air interfaces utilized by the communication systems include Frequency Division Multiple Access (FDMA), Time Division Multiple Access (TDMA), Code Division Multiple Access (CDMA), and Universal Mobile Telecommunications System (UMTS), the Long Term Evolution (LTE) of the UMTS, the Global System for Mobile Communications (GSM), and the like. By way of non-limiting example only, further description will relate to a CDMA communication system, but such teachings apply equally to other system types including the CDMA wireless communication system.

Referring now to FIG. 2, a CDMA wireless communication system is shown having a plurality of mobile terminals 100, a plurality of base stations (BSs) 270, base station controllers (BSCs) 275, and a mobile switching center (MSC) 280. The MSC 280 is configured to interface with a conventional Public Switch Telephone Network (PSTN) 290. The MSC 280 is also configured to interface with the BSCs 275. The BSCs 275 are coupled to the base stations 270 via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs 275 can be included in the system as shown in FIG. 2.

Each base station 270 may include one or more sectors, each sector having an omni-directional antenna or an antenna pointed in a particular direction radially away from the base station 270. Alternatively, each sector may include two or more different antennas. Each base station 270 may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations 270 may also be referred to as Base Station Transceiver Subsystems (BTSs). In some instances, the term “base station” may be used to refer collectively to a BSC 275, and one or more base stations 270. The base stations may also be denoted as “cell sites.” Alternatively, individual sectors of a given base station 270 may be referred to as cell sites. A broadcasting transmitter (BT) 295, as shown in FIG. 2, transmits a broadcast signal to the mobile terminals 100 operating within the system. The broadcast receiving module 111 (FIG. 1) can also be configured inside the mobile terminal 100 to receive broadcast signals transmitted by the BT 295.

FIG. 2 further depicts several Global Positioning System (GPS) satellites 300. Such satellites 300 facilitate locating the position of at least one of plural mobile terminals 100. Two satellites are depicted in FIG. 2, but it is understood that useful position information may be obtained with greater or fewer satellites than two satellites. The GPS module 115 (FIG. 1) can also be configured to cooperate with the satellites 300 to obtain desired position information. It is to be appreciated that other types of position detection technology, (i.e., location technology that may be used in addition to or instead of GPS location technology) may alternatively be implemented. If desired, at least one of the GPS satellites 300 may alternatively or additionally be configured to provide satellite DMB transmissions.

During an operation of the wireless communication system, the base stations 270 receive sets of reverse-link signals from various mobile terminals 100. The mobile terminals 100 are engaging in calls, messaging, and executing other communications, and each reverse-link signal received by a given base station 270 is processed within that base station 270. The resulting data is then forwarded to an associated BSC 275. Further, the BSC 275 provides call resource allocation and mobility management functionality including the orchestration of soft handoffs between base stations 270. The BSCs 275 also route the received data to the MSC 280, which then provides additional routing services for interfacing with the PSTN 290. Similarly, the PSTN 290 interfaces with the MSC 280, and the MSC 280 interfaces with the BSCs 275, which in turn control the base stations 270 to transmit sets of forward-link signals to the mobile terminals 100.

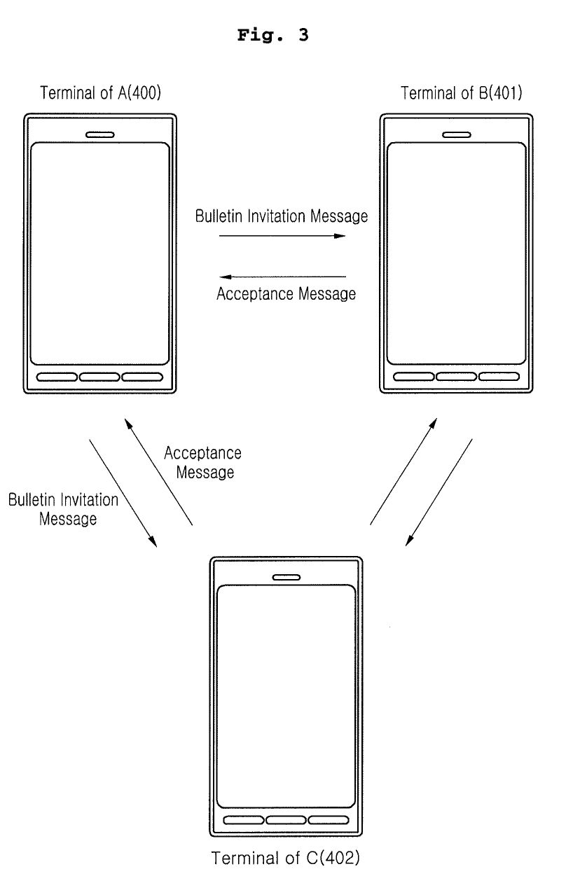

FIG. 3 is a network diagram of a wireless social networking service (SNS) according to an embodiment. The network of FIG. 3 may be configured using the network of FIG. 2, for example. An embodiment of the present invention provides a method for providing a virtual bulletin board on a network. In more detail, in FIG. 3, each user may exchange data with another user through terminals 400, 401 or 402. The terminals 400, 401 or 402 can be the mobile terminal shown in FIG. 1 or 2. Further, the data according to an embodiment of the present invention is transmitted through a data transmission protocol usable in the mobile terminal 100 such as SMS, MMS and e-mail. A proprietary protocol for a virtual bulletin board can also be used as well as currently available protocols.

In addition, although a touchscreen phone is illustrated as the terminals 400, 401 and 402, other types of mobile terminals may be used. Also, some of the terminals 400, 401 and 402 can be a non-mobile stationary terminal (e.g., capable of communicating data (e.g., e-mail) through wired communication).

As shown, FIG. 3 illustrates bulletin invitation and accepting messages for a virtual bulletin board between three members A, B and C. In this example, one member of the group performs an operation for generating a virtual bulletin board. Hereinafter, the member generating a virtual bulletin board will be referred to as a host, and the other members will be referred to as guests.

Thus, with respect to FIG. 3, if the host A generates a virtual bulletin board with a title ‘T’, the members B and C are designated as guests (i.e., receivers) and a message is transmitted to the guests for inviting them to the virtual bulletin board. As discussed above, according to embodiments of the present invention, the invitations, postings, acceptance messages, etc. can be transmitted through the data transmission protocol such as SMS, MMS and e-mail, or through a proprietary protocol for generating the virtual bulletin board.

In addition, the virtual bulletin board can be regarded as a homepage of the host (e.g., it was generated or initiated by the host). Further, the bulletin board invitation message can include a bulletin board title, information about the host, and information (e.g., phone numbers and names) about members to be invited to the bulletin board (i.e., information about guests).

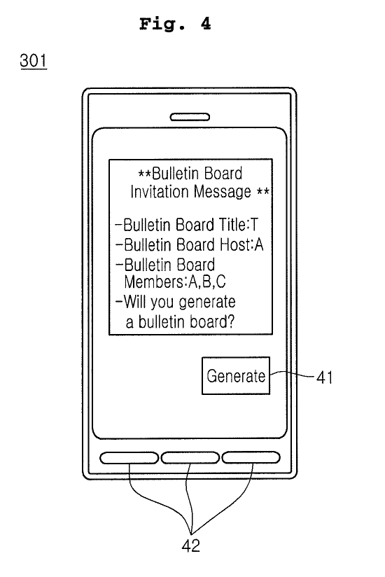

Next, FIG. 4 illustrates a bulletin board invitation message that can be displayed on the terminals 401 and/or 402 of the guests B or C receiving the bulletin board invitation message. As illustrated in FIG. 4, the bulletin board invitation message can include a bulletin board title, information about the host, and information about the guests. Also, in this embodiment, the invitation message asks the users if they want to join the bulletin board, and includes a generate button 41 that the users B and C can select to join or generate the bulletin board. For a touchscreen phone, the button 41 can be a soft button displayed on a touchscreen. If the mobile phone does not have a touchscreen, one of physical buttons 42 (e.g., a confirmation button and a call button) can be designated as the generation command button.

Thus, when the guest B or C presses the generate button 41 to accept the bulletin board invitation, a virtual bulletin T is generated in the terminal of the guest B or C. Further, frame information used to display the virtual bulletin board T, and a storage space for storing contents included in the virtual bulletin board T are physically generated or allocated in the terminal 401 or 402 of the guests B and/or C. If SMS, MMS or e-mail is used in the above data communication, a folder for the virtual bulletin board T can be generated in a storage folder for each SMS, MMS and e-mail.

A storage space for a virtual bulletin board can also be generated or allocated in the terminal of the host A simultaneously with the transmission of the bulletin board invitation message, or after an acceptance message from the guests B and/or C have been received. Also, according to an embodiment of the present invention, a bulletin board member address book including the A, B and C users can be generated and stored in the terminals of A, B and C before or after generation of the virtual bulletin board in the terminals of A, B and C so as to facilitate transmission of a message to the members of the bulletin board. Thereafter, the bulletin board member address book can be used to upload contents to the bulletin board or transmit data to the bulletin board members.

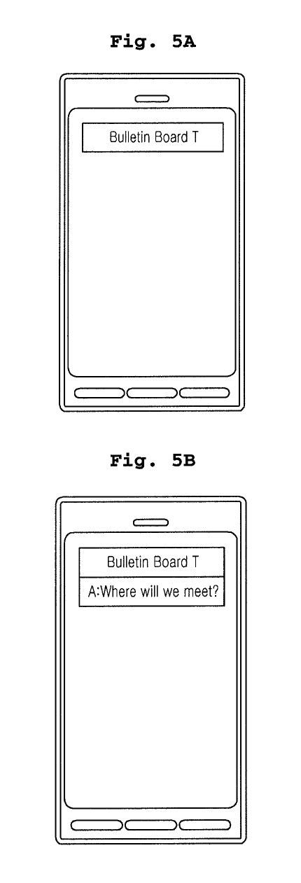

Also, when each of the bulletin board members A, B and C opens the generated virtual bulletin board on its own terminal, the generated virtual bulletin board can be displayed as illustrated in FIG. 5A. In addition, initial contents to be initially uploaded to the virtual bulletin board can be included in the bulletin board invitation message transmitted by the host A. In this instance, the virtual bulletin board including the initial contents of A can be displayed as illustrated in FIG. 5B. Further, the contents displayed in the bulletin board can be text messages, multimedia data such as image files, video files and sound files, or files downloadable through the network.

Further, in FIGS. 5A and 5B, the virtual bulletin board according to an embodiment of the present invention can include a bulletin board title, information about a member uploading contents, and a list of uploaded contents may be displayed in the bulletin board. The bulletin board members can then select one of the listed contents to open the details of the contents or to download files included in the contents.

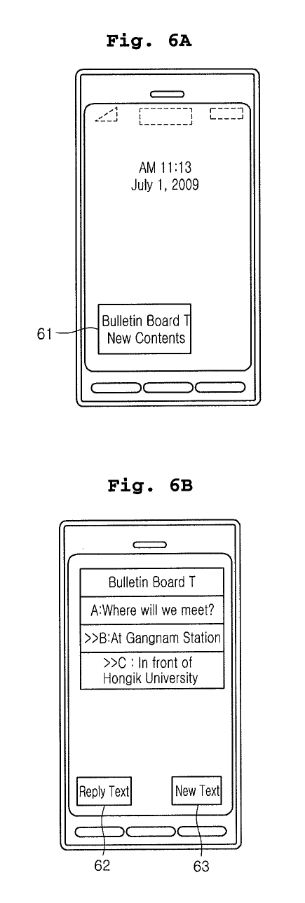

In addition, the guests B or C can also upload contents to the bulletin board. In this instance, a message for notifying the presence of new contents in the bulletin board T can be displayed in the terminal of another bulletin board member, as illustrated in FIG. 6A. A member can then select a notification button 61 to view the new contents. Thus, the receiving user can selectively view contents from user they desire and ignore contents from other users. Also, a separate menu option can be used to display the virtual bulletin board T. Further, when the guests B and C upload reply-type contents in response to the initial contents of the host A, the reply-type contents are displayed on the bulletin boards of the terminals A, B and C.

As illustrated in FIG. 6B, each of the bulletin board members A, B and C can select a reply button 61 to upload contents or create a reply-type message in response to texts uploaded by other members, or select a new text button 62 to upload new contents or a new message. As discussed above, the uploaded contents can be transmitted to other bulletin board members using SMS, MMS or e-mail.

Further, when the contents uploaded to the bulletin board include a short text message, the uploaded contents can be displayed in one line as illustrated in FIG. 6B. However, for a long text message, a list including only a portion of the message can be displayed, and a user can then select one of the lists to display the remainder of the corresponding message.

According to the above configuration, a text message of a mobile phone, an e-mail system, or an e-mail system of a general PC may be used to provide a social network service on a network. Further, a bulletin board host can simplify a bulletin board generation process and bulletin board members can use a bulletin board on a network without a separate club entry process.

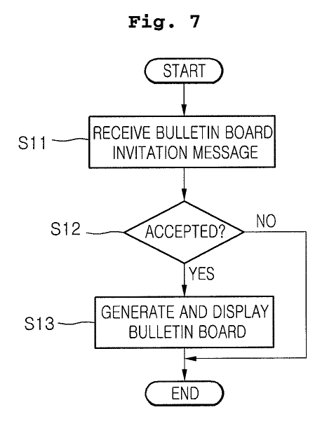

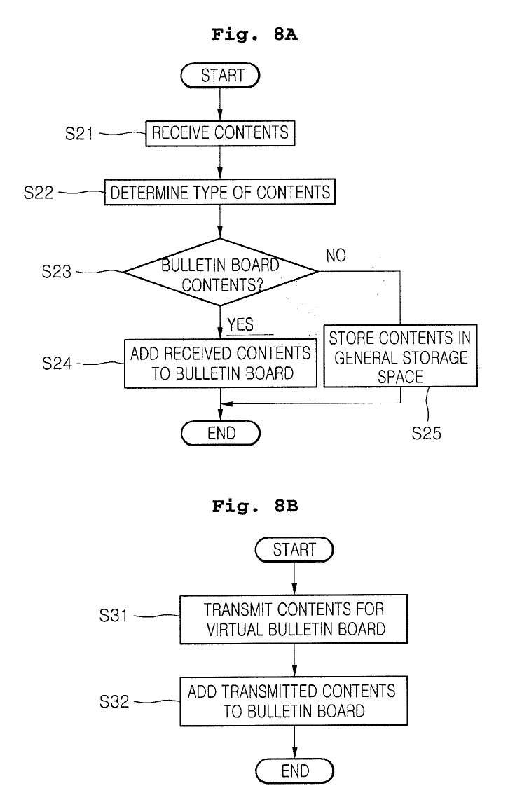

Next, FIG. 7 is a flow chart illustrating a virtual bulletin board generation method according to an embodiment of the present invention. The method illustrated in FIG. 7 can be implemented in the terminals 401 and/or 402 of the guests B and/or C (i.e., the guest member invited to the virtual bulletin board).

As shown in FIG. 7, when the host A transmits a bulletin board invitation message to the guests B and C, the guests B and C receive the invitation message (step S11). The guests B and C then determine whether to accept the bulletin board invitation (S12). If the guests do not accept the invitation (No in S12), the process ends. If the invitation is accepted (Yes in S12), a bulletin board is generated and displayed in the terminals 401 and/or 402 of the guests B and/or C that accepted the invitation (S13). FIGS. 4, 5A and 5B illustrate these features

Further, the generating and displaying the bulletin board in the terminals 401 and/or 402 of the guests B and/or C include in one embodiment, generating frame information used for displaying the virtual bulletin board T, and generating or allocating a storage space for storage of contents to be uploaded to the virtual bulletin board. If an SMS, an MMS or an e-mail is used as the data communication protocol for providing the virtual bulletin board, a virtual bulletin board folder can be separately generated in a storage folder for the SMS, the MMS or the e-mail.

Next, FIG. 8A is a flow chart illustrating a method for one of the virtual bulletin board members to receive contents uploaded to a generated virtual bulletin board according to an embodiment. Referring to FIG. 8A, when contents for a virtual bulletin board are received (step S21), the type of the received contents is determined (step S22). That is, the received contents are analyzed to determine if the contents correspond to an SMS, MMS or e-mail or a bulletin board message. The determination can be performed by including an identifier in a title of a bulletin board message or in a header portion and determining the presence of the identifier. Also, when using a proprietary protocol for a virtual bulletin board, an identifier for identifying contents can be included in a header portion.

Then, if the received contents are determined to be a bulletin board message (Yes in step S23), the received contents are added to the virtual bulletin board of the user (step S24). If the received contents are not a bulletin board message (No in step S23, the received contents are stored in a general storage space (step S25). Thereafter, the process ends.

Further, according to an embodiment of the present invention, not all of the contents are received in step S21 (e.g., only a contents arrival notification message may be received). Thus, in this instance, when a user makes a contents reception request in response to the notification message, the contents are received and added to the bulletin board.

Next, FIG. 8B is a flow chart illustrating a method for uploading contents to a generated virtual bulletin board according to an embodiment of the present invention. Referring to FIG. 8B, the contents for a virtual bulletin board are created and transmitted (step S31). FIG. 6B illustrates the displayed virtual bulletin board, in which the virtual bulletin board contents can be created by selecting the reply text button 62 or the new text button 63. A virtual bulletin board contents creation menu can also be used to create bulletin board contents. Further, text can be created or a file such as multimedia can be selected and uploaded. The contents are then displayed on the bulletin board (step S32).

In addition, according to another embodiment of the present invention, when all members of the bulletin boards are designated as receivers, the virtual bulletin board contents can be automatically set. Also, after transmission of the contents, the transmitted contents may also be added to a virtual bulletin board of a terminal of the transmitter.

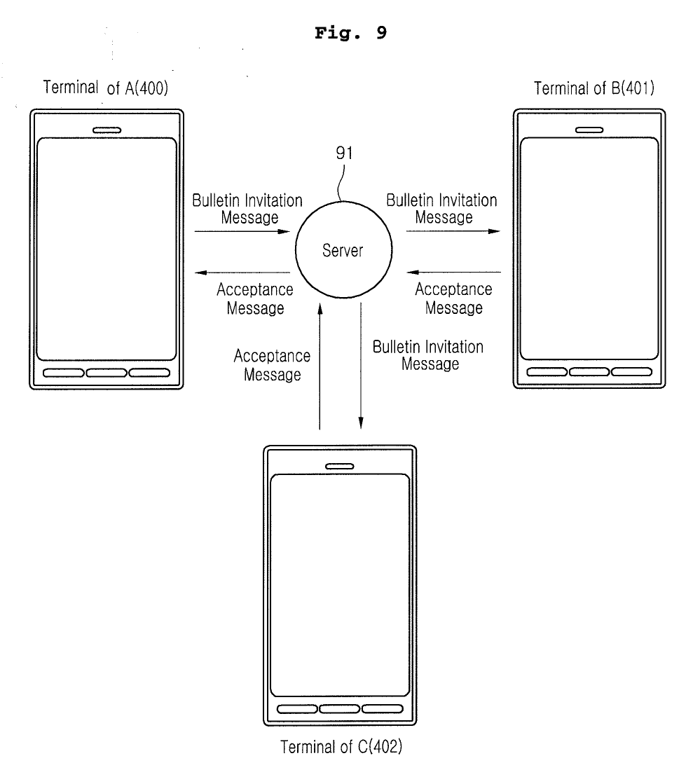

Next, FIG. 9 is a diagram illustrating a network configuration including a dedicated server for operating a virtual bulletin board according to an embodiment of the present invention. The network of FIG. 9 can use the BSC 275 of the network in FIG. 2 as a dedicated server, or use a separate dedicated server for providing a virtual bulletin board service.

Referring to FIG. 9, a dedicated server 91 stores virtual bulletin board contents transmitted/received by virtual bulletin board members and transmits the stored contents at the request of the member, which will be described later. In this example, the host A generates a bulletin board having A, B and C as members. The host A also uses the terminal 400 to transmit a bulletin board invitation message through the server 91, and the server 91 transmits a bulletin board invitation message to the terminals 401 and 402 of the guests B and C. Also, the server 91 receives a bulletin board acceptance message from the terminal 401 and 402 of the guests B and C and transmits the received bulletin board acceptance message to the terminal 400 of the host A.

If the guests accept the invitation, the server 91 stores a virtual bulletin board having A, B and C as members therein or in a database connected thereto, and transmits contents of the virtual bulletin board at the request of the members A, B and C. After generating the virtual bulletin board, and if the members A, B and C upload contents to the virtual bulletin board, the server 91 internally stores the contents or in a connected database and simultaneously transmits the contents to the other members.

Further, as discussed above, the multimedia data can be text messages, multimedia data such as image files, video files and sound files, or files downloadable through the network. Also, according to an embodiment of the present invention, the reception of the contents is notified, and the contents are transmitted to a member that has requested reception of the contents.

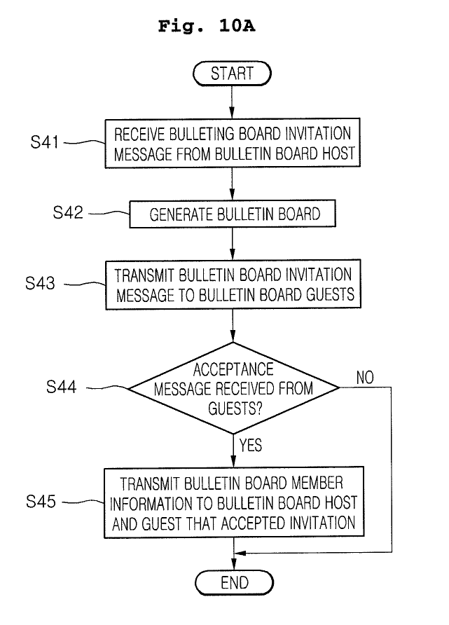

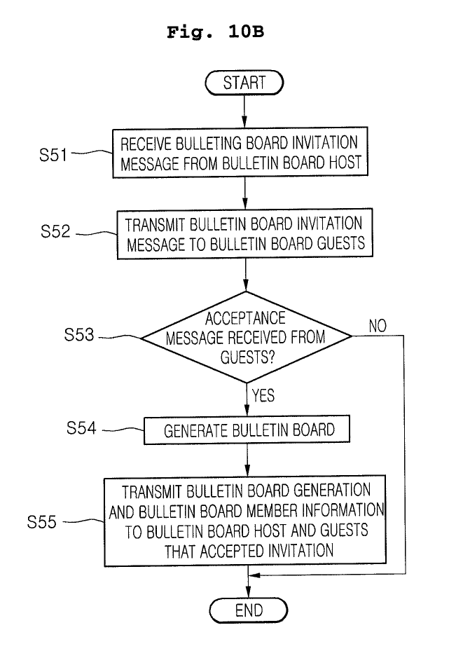

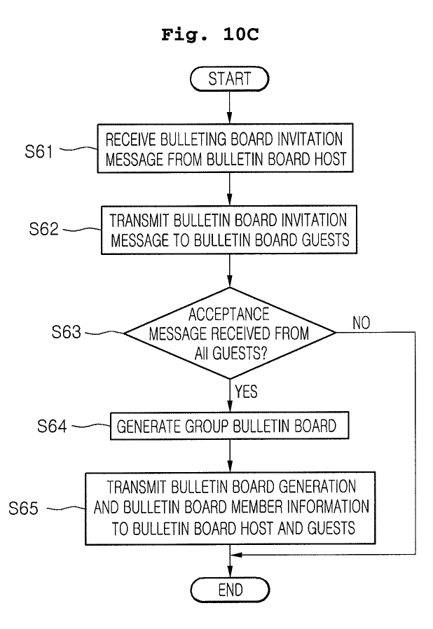

Next, FIGS. 10A to 10C are flow charts illustrating embodiments of a virtual bulletin board generation method implementable in the network system of FIG. 9. Specifically, FIGS. 10A to 10C illustrate a process performed by the server 91 during the generation of a virtual bulletin board. In FIG. 10A, when the dedicated server 91 of FIG. 9 receives a bulletin board invitation message for generating a bulletin board from a bulletin board host, a bulletin board is generated in the dedicated server 91 (S41 and S42).

The server 91 then transmits a bulletin board invitation message to guests (step S43). If an acceptance message is received from the guests (Yes in step S44), bulletin board member information is transmitted to the host and the guests, which have accepted the invitation (step S45).

Further, the bulletin board member information can include information about the bulletin board host, the invited members, and a list of the members that have accepted the invitation. Step S45 can also be performed whenever receiving an acceptance message from a guest. The bulletin board member information can also be transmitted to all the members including the members that have not yet accepted the invitation.

Next, in FIG. 10B, when transmitting a bulletin board invitation message from a bulletin board host to guests and receiving an acceptance message from one of the guests, the dedicated server 91 generates a bulletin board. In particular and as shown in FIG. 10B, a bulletin board invitation message is received from a bulletin board host (step S51). The invitation message is then transmitted to bulletin board guests designated in the invitation message (step S52). If an acceptance message is received from one of guests (Yes in step S53), a bulletin board is generated (step S54). Bulletin board member information is also transmitted to the bulletin board host and all the guests or the guests that have accepted the invitation (step S55). Step S55 can also be performed whenever receiving an acceptance message from a guest.

Next, in FIG. 10C, the dedicated server 91 generates a bulletin board when transmitting a bulletin board invitation message from a bulletin board host to guests and receiving an acceptance message from all the guests. In particular, and as shown in FIG. 10C, a bulletin board invitation message is received from a bulletin board host (step S61), and the invitation message is transmitted to bulletin board guests designated in the invitation message (step S62).

If an acceptance message is received from all the guests (Yes in step S63), a bulletin board is generated (step S64). Also, bulletin board member information is transmitted to the bulletin board host and all the guests (step S65). Thereafter, the process ends. Further, the bulletin board of step S64 may be generated if an acceptance message is not received from some guests for more than a predetermined time.

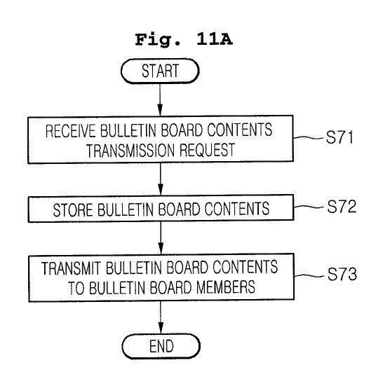

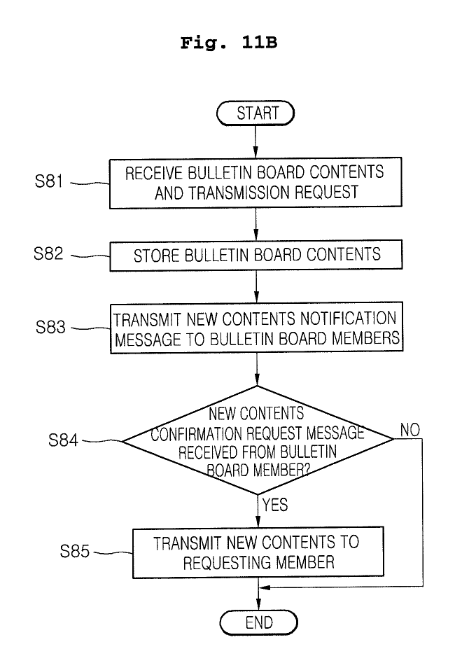

Next, FIGS. 11A and 11B are flow charts illustrating an embodiment of a virtual bulletin board contents transmission method implementable in the network system of FIG. 9. Specifically, FIGS. 11A and 11B illustrate a process performed by the server 91.

In the embodiment of FIG. 11A, contents received from a transmitter are directly transmitted to group members. This method can be used when the contents are small, that is, when the contents are text data or small image data. In more detail, and referring to FIG. 11A, bulletin board contents and a transmission request are received from a bulletin board contents transmitter (step S71). The received contents are then stored in the server or in a connected database (step S72). The received contents are then transmitted to group members (step S73).

Next, FIG. 11B illustrates a virtual bulletin board contents transmission method according to another embodiment of the present invention. Further, this method can be used when the contents are large, that is, when the contents are a long text message, a large image or a video. Referring to FIG. 11B, bulletin board contents and a transmission request are received from a transmitter (step S81).

The received contents are then stored in the server 91 (step S82), and the update of the new contents is notified to the members except the contents transmitter (step S83). Further, if a contents confirmation request is received from one of the members (Yes in step S84), the new contents are transmitted to the member, which has transmitted the confirmation request (step S85). Further, the embodiments of the present invention can be applied to various types of social network services, as well as a bulletin board service.

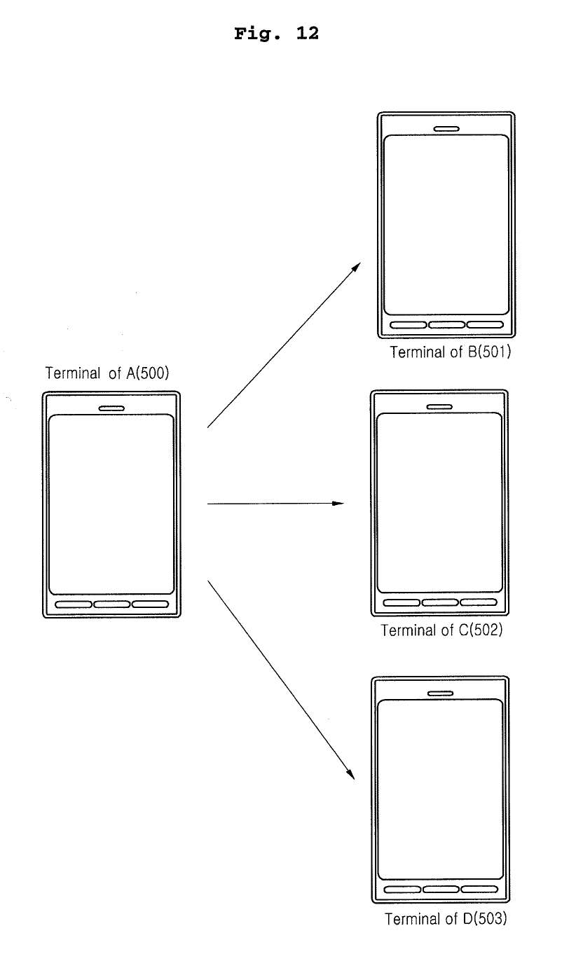

Next, FIG. 12 is a diagram illustrating a social network designating a receiver receiving text or contents according to an embodiment of the present invention. In this embodiment, a homepage host generates a homepage that can be visited by only three guests B, C and D. Also, the contents accessible by each of the three guests are restricted. Hereinafter, a user generating a homepage will be referred to as a host, and users visiting the homepage will be referred to as guests. Similar to the above embodiments, the contents may include text messages, multimedia files or downloadable files.

Similar to the terminals 400, 401 and 402 in FIG. 9, the terminals 500, 501 and 502 in FIG. 12 can be the mobile terminal 100 of FIG. 1 or 2. Data can also be transmitted through data transmission protocols usable in the mobile terminal 100 such as SMS, MMS and e-mail. A proprietary protocol for a virtual bulletin board can also be used as well as other available protocols. Further, although a touchscreen phone is illustrated as the terminals 500, 501, 502 and 503 in FIG. 12, other types of mobile terminals may be used. Also, some of the terminals 500, 501, 502 and 503 may be a non-mobile terminal capable of communicating data (e.g., e-mail) through wired communication.

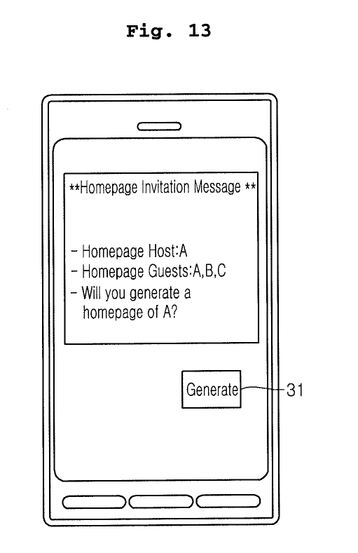

Further, the host A can use its own terminal 500 to transmit a homepage invitation message to guests, that is, persons visiting the homepage. In this embodiment, guests B, C or D are designated as receivers, that is, homepage guests. Other users except B, C and D cannot access the homepage of A. In addition, the terminals 501, 502 and 503 of the guests B, C or D receive a homepage invitation message as illustrated in FIG. 13.

FIG. 13 also illustrates the homepage invitation message include information about a homepage inviter (i.e., a homepage host) and a list of persons permitted to visit the homepage (i.e., a guest list). When a guest presses the homepage generation button 31, a homepage storage space is generated in the corresponding terminals. Further, the homepage of a social network service according to embodiments of the present invention is configured to store homepage contents in the terminals of guests, instead of storing homepage data in a specific server.

After generating a homepage, that is, after generating a homepage storage space in the terminals of guests, and if the host A wants to upload contents to the homepage, the host A can designate the guests as receivers to transmit the contents. As illustrated in FIG. 14, a message for notification of new contents can be displayed on the terminals 501, 502 or 503 of guests B, C and D.

In addition, the guests B, C and D, which has received the message of FIG. 14, opens the corresponding message, and accesses the server to detect the corresponding contents such as text, pictures and videos. Further, the contents can be transmitted together with a notification message illustrated in FIG. 14. If the contents are transmitted with the notification message, a process of accessing the server to download the contents can be omitted.

Further, when the host transmits a homepage generation request to guests and transmits contents by designating the guests as receivers without receiving an acceptance message, a notification message is displayed as illustrated in FIG. 14. When the message is detected by the guests, a homepage storage space of the host is automatically generated in the terminals of the guests. According to the above configuration, a social network service can be implemented on a mobile communication network.

In addition, a separate dedicated server can be used for operation of the homepage. In this instance, the dedicated server can use a proprietary protocol for operating the homepage to exchange homepage contents with the terminals of the guests. Also, the dedicated server can store contents uploaded to the homepage, and transmit the contents in response to a contents confirmation request of the authorized guests, i.e., the guests designated as receivers by the host. In this instance, the network configuration of FIG. 9 can be used, in which the terminal 400 of host A is a host terminal and the terminals 401 and 402 are guest terminals.

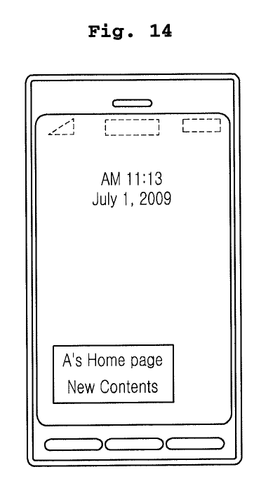

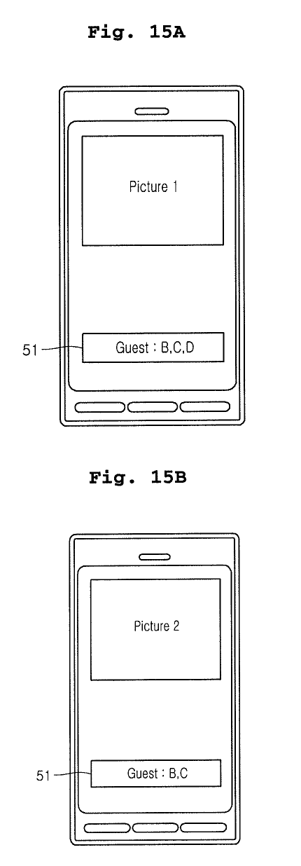

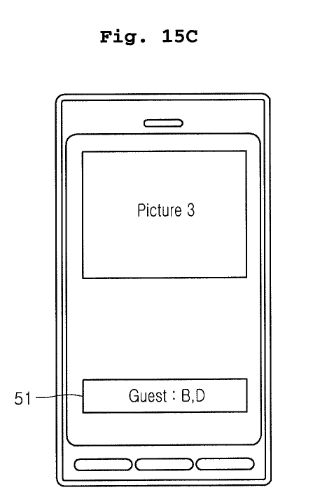

Further, the user can restrict the access authority for each of the contents by designating receivers differently whenever transmitting the homepage contents. For example, FIGS. 15A to 15C illustrate a method for transmitting contents by designating a receiver of homepage contents differently depending on the contents according to an embodiment of the present invention.

As illustrated in FIGS. 15A to 15C, the homepage host A can transmit homepage contents by designating guests differently for each of the contents. In more detail, the host A transmits a picture 1 to guests B, C and D in FIG. 15A; the host A transmits a picture 2 to guests B and C in FIG. 15B; and the host A transmits a picture 3 to guests B and D in FIG. 15C.

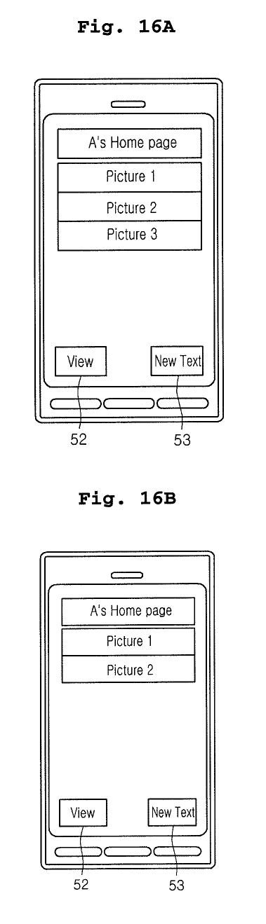

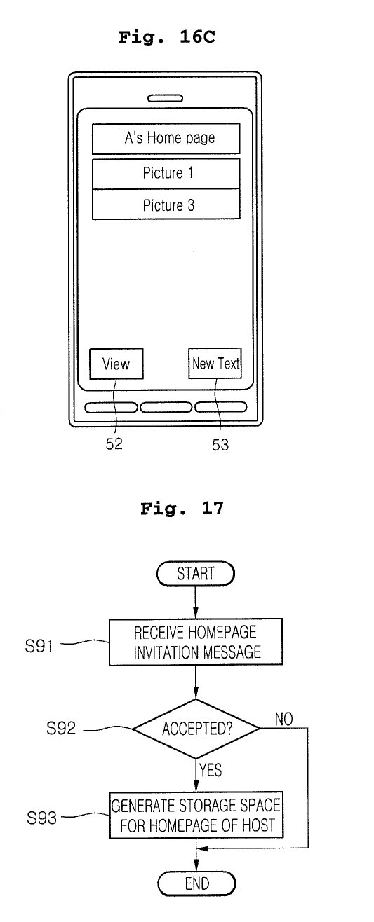

Thus, the pictures 1, 2 and 3 transmitted by the host A are uploaded as contents in a homepage of the terminal of guest B as illustrated in FIG. 16A; only the pictures 1 and 2 are uploaded as contents in the terminal of guest C as illustrated in FIG. 16B; and only the pictures 2 and 3 are uploaded in the terminal of guest C as illustrated in FIG. 16C. Further, each of the guests B, C and D can select and view the pictures uploaded in its own terminal, or download and view the corresponding picture from the server.

Therefore, the host A can advantageously restrict the contents access authority for each of the guests, i.e., the users accessing the homepage. That is, it is possible to designate the authority or the access level for each guest accessing a homepage. Also, although pictures are explained in the above embodiments, this concept can also be applied to text messages or other types of multimedia files.

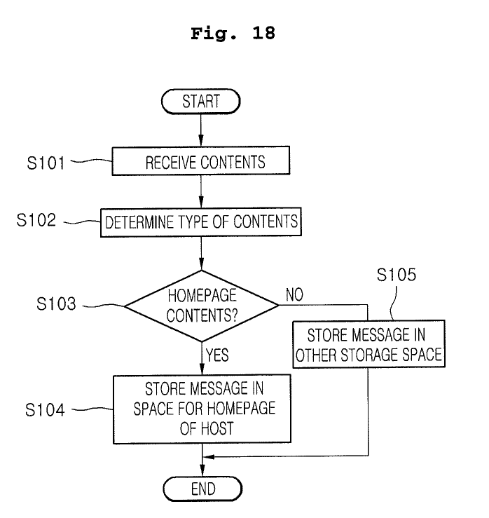

Next, FIG. 17 is a flow chart illustrating a mobile homepage generation method implemented in the terminal of the guests B, C and D of (i.e., the homepage guests) according to another embodiment of the present invention. Referring to FIG. 17, a homepage invitation message is received from the homepage host A (step S91). If the invitation is accepted (Yes in step S92), a homepage of the host A is generated in the terminal of the guests B, C and/or D (S93). Further, generating the homepage can include generating a storage space for storing basic frame data for the homepage and contents for the homepage.

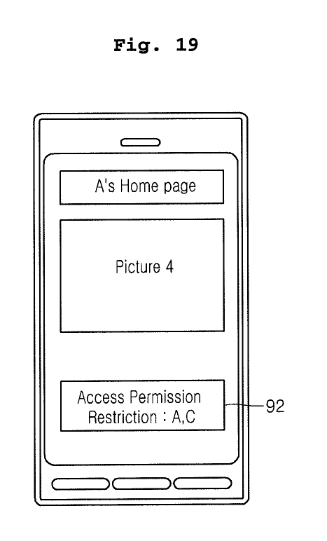

Next, referring to FIG. 18, homepage guests can also upload contents to the homepage. For example, as shown, the host receives contents from the homepage guests (S101), determines the type of received contents (S102), and if the received contents are homepage contents (Yes in S103), the host stores the received contents (S105). If the received contents are not homepage contents (No in S105), the contents are stored in another space (S105). For example, the contents may be uploaded as illustrated in FIG. 19 by selecting a menu for uploading contents to a predetermined separate homepage or selecting a new text button 152 with the host A's homepage opened as illustrated in FIG. 16A, 16B or 16C.

When the homepage guest uploads contents, the contents are transmitted only to users 92 accessible to the contents. The contents can be transmitted to the homepage host and the accessible users, and the transmitted contents can be received by the accessible user according to the method of FIG. 8. In addition, for a network system including a dedicated server, the transmitted contents can be received according to a method similar to FIG. 11B.

The present invention provides several advantages. For example, in a typical web-based social network service, the user must first subscribe to the web service and separately access a web site. The typical social network service requires not only a service subscription process but also processes for searching friends, making friend requests and performing an admission operation in order to associate with other friends. This is a complicated process and very time consuming.

However, social network services according to embodiments of the present invention are much more convenient because a text message service or an e-mail service can be used. Also, the social network services according to the embodiments of the present invention have excellent security features and are convenient for setting the authority for access to a homepage or a cyber (virtual) bulletin board.

Thus, embodiments of the present invention provide a novel social network service that is convenient to use and includes a service infrastructure such as a text message service or an e-mail service. Embodiments of the present invention also provide a social network service that has high security and is convenient to set different authority levels for access to a homepage or a cyber (virtual) bulletin board.

Also, because the bulletin board and related postings, contents, etc. are performed using the messaging service on the terminal such as SMS, MMS and email, the user of the terminal does not have to log onto a social network service site to access a bulletin board, and the user can create a bulletin board that other user can post on without having to enter user ids (which first have to be created), passwords, etc.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for controlling a mobile terminal, the method comprising:
receiving, via a wireless communication unit and using a messaging service on the mobile terminal, a bulletin board invitation message from a host terminal and including an invitation to join a bulletin board created by the host terminal;
transmitting, via the wireless communication unit and using the messaging service, an acceptance message to the host terminal indicating the mobile terminal accepts the invitation for joining the bulletin board created by the host terminal;
displaying, on a display of the mobile terminal, the bulletin board created by the host terminal; and
transmitting, via the wireless communication unit and using the messaging service, contents to be displayed on the bulletin board to the host terminal.

2. The method of claim 1, further comprising:
receiving, via the messaging service, bulletin board contents from the host terminal; and
displaying, on the display of the mobile terminal, the bulletin board contents received from the host terminal.

3. The method of claim 2, further comprising:
displaying, on the display of the mobile terminal, a prompt asking a user of the mobile terminal if they want to receive and display the bulletin board contents transmitted by the host terminal, before the receiving and displaying the bulletin board contents.

4. The method of claim 1, further comprising:
receiving, via the messaging service, bulletin board contents transmitted from at least one other terminal that accepted the invitation for joining the bulletin board created by the host terminal; and
displaying, on the display, the bulletin board contents received from the at least one other terminal.

5. The method of claim 4, further comprising:
displaying, on the display of the mobile terminal, a prompt asking a user of the mobile terminal if they want to receive and display the bulletin board contents from the at least one other terminal, before the receiving and displaying the bulletin board contents.

6. The method of claim 1, further comprising:
inputting, via an input unit, bulletin contents to be displayed on the bulletin board created by the host terminal;
transmitting, via the messaging service, the input bulletin board contents to the host terminal; and
displaying the input bulletin board contents on the bulletin board of the host terminal and on the bulletin board of the mobile terminal.

7. The method of claim 1, wherein the acceptance message includes at least one of a title of the bulletin board, a name of the host terminal, and names of invited guests to the bulletin board created by the host terminal.

8. The method of claim 1, wherein the bulletin board is a homepage designated by the host terminal.

9. The method of claim 2, further comprising:
notifying the host terminal that the bulletin board contents have been received by the mobile terminal.

10. The method of claim 2, wherein the messaging service includes one of SMS, MMS and email, and
wherein the bulletin board contents include at least one of a text message, a multimedia file and a file downloadable through the network.

11. The method of claim 2, wherein the bulletin board invitation message is received from a dedicated server serving between the host terminal and the mobile terminal, the acceptance message is transmitted to the dedicated server and then the dedicated server transmits the acceptance message to the host terminal, and the bulletin board contents are transmitted to the dedicated server and then the dedicated server transmits the bulletin board contents to the mobile terminal.

12. The method of claim 11, wherein the dedicated server transmits the bulletin board invitation message from the host terminal to at least one other terminal and including the invitation to join the bulletin board created by the host terminal.

13. A mobile terminal, comprising:
a wireless communication unit configured to use a messaging service on the mobile terminal to receive a bulletin board invitation message from a host terminal and including an invitation to join a bulletin board created by the host terminal, and to transmit using the messaging service an acceptance message to the host terminal indicating the mobile terminal accepts the invitation for joining the bulletin board created by the host terminal; and
a display configured to display the bulletin board created by the host terminal,
wherein the wireless communication unit is further configured to transmit contents to be displayed on the bulletin board to the host terminal using the messaging service.

14. The mobile terminal of claim 13, wherein the wireless communication unit is further configured to receive, via the messaging service, bulletin board contents from the host terminal, and
wherein the display is further configured to display the bulletin board contents received from the host terminal.

15. The mobile terminal of claim 14, wherein the display is further configured to display a prompt asking a user of the mobile terminal if they want to receive and display the bulletin board contents transmitted by the host terminal, before the bulletin board contents are received and displayed.

16. The mobile terminal of claim 13, wherein the wireless communication unit is further configured to receive, via the messaging service, bulletin board contents transmitted from at least one other terminal that accepted the invitation for joining the bulletin board created by the host terminal, and
wherein the display is further configured to display the bulletin board contents received from the at least one other terminal.

17. The mobile terminal of claim 16, wherein the display is further configured to display a prompt asking a user of the mobile terminal if they want to receive and display the bulletin board contents from the at least one other terminal, before the bulletin board contents are received and displayed.

18. The mobile terminal of claim 13, further comprising:
an input unit configured to input bulletin board contents to be displayed on the bulletin board created by the host terminal,
wherein the wireless communication unit is further configured to transmit, via the messaging service, the input bulletin board contents to the host terminal, and
wherein the input bulletin board contents are displayed on the bulletin board of the host terminal and on the bulletin board of the mobile terminal.

19. The mobile terminal of claim 13, wherein the acceptance message includes at least one of a title of the bulletin board, a name of the host terminal, and names of invited guests to the bulletin board created by the host terminal.

20. The mobile terminal of claim 13, wherein the bulletin board is a homepage designated by the host terminal.

21. The mobile terminal of claim 14, wherein the wireless communication unit is further configured to notify the host terminal that the bulletin board contents have been received by the mobile terminal.

22. The mobile terminal of claim 14, wherein the messaging service includes one of SMS, MMS and email, and
wherein the bulletin board contents include at least one of a text message, a multimedia file and a file downloadable through the network.

23. The mobile terminal of claim 14, wherein the bulletin board invitation message is received from a dedicated server serving between the host terminal and the mobile terminal, the acceptance message is transmitted to the dedicated server and then the dedicated server transmits the acceptance message to the host terminal, and the bulletin board contents are transmitted to the dedicated server and then the dedicated server transmits the bulletin board contents to the host terminal.

24. The mobile terminal of claim 23, wherein the dedicated server transmits the bulletin board invitation message from the host terminal to at least one other terminal and including the invitation to join the bulletin board created by the host terminal.
